(19) United States
(12) Patent Application Publication
(10) Pub. No.: US 2004/0068423 A1
(43) Pub. Date: Apr. 8, 2004

(54) Graphical user interfaces for sets of medical image data files

(76) Inventor: Grant D. Shaw, Hampshire (GB)

Correspondence Address: RENNER, OTTO, BOISSELLE & SKLAR, LLP, Nineteenth Floor, 1621 Euclid Avenue, Cleveland, OH, 44115-2191, US

(21) Appl. No.: 10/264,276

(22) Filed: Oct. 3, 2002

(51) Int. Cl. G06F 17/60; G06F 17/00; G06F 7/00

(52) U.S. Cl. 705/3; 707/104.1

(57) ABSTRACT

In a PACS environment, an overview of patient's history made up of a potentially large number of digital images is displayed as a two-dimensional array of thumbnails sorted by date in a one direction and anatomical feature in a second direction. From this very simple two-dimensional ordering of thumbnail images it is possible to appreciate an amazingly large amount about the patient's history. The information is deduced in a fully intuitive simple fashion, without having to study any patient history notes. The intuitive understanding of the patient's history comes in part from the special layout of the thumbnails which gives the user information on what images were taken at what time, in part from the fact that the user can see some major features of the image content in the thumbnails, and in further part because the user is able to intuitively combine the thumbnail layout and image content information.

### BACKGROUND OF THE INVENTION

The invention relates to medical imaging, and in particular to the handling and graphical representation of sets of medical images in a computerized environment.

Medical imaging is now done in large part digitally and this trend will continue. Digital acquisition techniques include computerized tomography (CT), magnetic resonance (MR), positron emission tomography (PET), some ultrasound, some X-ray angiography, and computed radiography (CR) and digital radiography (DR). The image files may contain three-dimensional (3D) image data, such as for CT or MR scans, or two-dimensional (2D) image data, such as for CR or DR radiography data. As well as the image data, the image files will typically contain other data relevant to the image, such as modality, patient details, details of the image content and so forth. The non-image data is typically stored as text.

Medical image data files are archived and accessed in a hospital environment by so-called picture archiving and communication systems (PACS). This is a generic term used to describe a high-bandwidth hospital network used for handling the image files. Individual workstations on the network allow a physician to interpret, manipulate and analyze previously obtained data.

Historically, PACS systems were principally developed for radiology departments where they are essential for handling the large image data files produced by CT or MR scans. In a radiology department, workstations are provided with very large area monitors, often double monitors, to allow a radiographer to open and view several images simultaneously.

PACS networks are now spreading out to other hospital departments which rely on medical image data, such as orthopedic departments. However, outside the radiology department the workstations will typically only have standard size single monitors, for example 19 inch. The needs of an orthopedic department are quite different from those of a radiology department.

A primary problem in orthopedic departments is the sheer number of patients visiting each clinic. It is usual for 100 or more patients to present in a single clinic. Moreover, the patients will often not present at a set time, since the timing of their appearance will be dictated by previous actions, such as the acquisition of new medical images prior to consultation with a surgeon. Furthermore, it is common for orthopedic patients to appear at intervals over a long period of time, over weeks, months or years. For example, a trauma patient may undergo a healing process of a year or more, and a rheumatoid arthritis sufferer may be under observation and treatment for decades. In both cases, it is usually vital to compare a set of X-ray (or other) images taken on one or more previous occasions, with a corresponding set of X-ray (or other) images taken immediately prior to the patient consultation. Within this work environment several specific problems arise. There is the problem of choosing the clinically relevant images to display from what may be a large dossier. There are also the problems inherent in handling and displaying those images on the workstation which will usually only have a standard monitor.

FIG. 1 shows the pre-PACS environment in an orthopedic department. A surgeon is shown preparing for a patient consultation. A specific example is used for convenience to illustrate the problems of finding the particular X-rays of interest in a fracture clinic. The patient, Mr Frank, was involved in a serious road traffic accident. He fractured most of the long bones in both legs and in his right arm. He was resuscitated in hospital, went to theater and had numerous operations. He was in intensive care for a week. It is now over a year from that accident and he presents in the fracture clinic. The surgeon's problem is to find the images to allow him to treat the patient correctly. With the traditional pre-PACS system it is evident that this kind of patient will have a large number of plain X-rays, around 120 in the example of Mr Frank. They have been carefully color coded by the radiographers, where the colors are used to indicate date order and the color coding scheme is documented in a cardboard folder. The color coding is helpful, but its benefits are limited. What the surgeon wants to do first is to choose a body part of interest, for example the left tibia, and then to find all the images that relate to the left tibia in that pile of 120 images. The color coding is not helpful at this stage. The surgeon will then pin up all the left tibia images in date order onto a wall-mounted light board which is typically capable of taking 6 or 7 images at one time. Once all the images of the body part of interest are pinned up in sequential date order, the surgeon can then look from one end of the light board to the other to follow the fracture healing process, specifically to see what problems have occurred and how the process is progressing.

Unfortunately, standard PACS systems do not solve these problems. In fact, they make the problem of choosing the correct images worse. This is not only since the standard workstation display is much smaller than a light board, but also because the conventional color coding scheme is lost.

FIG. 2 shows a front image selection page typical of current PACS systems. To obtain this page, the user selects the patient. In response to the patient selection, the user is presented with a screen as illustrated that is text based and made up of a list of all the X-rays or other images that have been taken of that patient. The illustrated example is the first part of the image selection page of Mr Frank, bearing in mind that Mr Frank has 120×-rays and there are only about 30 shown on this page.

Mr Frank's name, sex, patient identifier and date of birth appear in each line to show that the correct patient has been selected. Each line also shows the date of when the image was taken. It can be seen that at least nine images were taken on 11 Apr. 2000 and that these are not listed in one block. There may be more 11 Apr. 2000 images off screen, bearing in mind that only around a quarter of the Mr Frank's images are currently on screen. To be able to progress, the surgeon will need to open each of the 11 Apr. 2000 images in turn until the one of interest is found, but this is not easy on a standard monitor. The surgeon may then wish to compare the selected 11 Apr. 2000 image, with a comparable image taken on another date, for example a comparable image taken immediately after surgery. But when was the surgery performed, and which is the more representative post-operative image?

It is therefore apparent that the standard text-based PACS image selection page illustrated could hardly be less well suited to handling a large set of medical images of an individual patient in the manner required by many clinicians.

### SUMMARY OF THE INVENTION

According to a first aspect of the invention there is provided a method of representing a patient record comprising a plurality of medical images stored as image files on a computer system, comprising: selecting a plurality of image files relating to an individual patient; identifying a date and body part for each of the image files; and providing an overview of the medical images of the individual patient on a display as thumbnails sorted by date in a first dimension and anatomical feature in a second dimension.

From this very simple two-dimensional ordering of thumbnail images it is possible to appreciate an amazingly large amount about the patient's history. The information is deduced in a fully intuitive simple fashion, without having to study any patient history notes. To fully appreciate the power of this representation, reference is made to the specific patient history examples given in the detailed description below. After having gone through these patient history examples, the reader will appreciate that the intuitive understanding of the patient's history comes in part from the special layout of the thumbnails which gives the user information on what images were taken at what time, in part from the fact that the user can see some detail of the image content in the thumbnails notwithstanding their small size, such as major fractures, bone screws, splints and prostheses, and in further part because the user is able to intuitively combine the thumbnail layout and image content information.

Nothing like this is possible from a text based image selection system, or a pre-PACS film and lightboard system.

As well as speed and ease of use for the clinician, the thumbnail based system has another major advantage over a conventional PACS system. Existing PACS systems are used in a manner that emulates the pre-computer practice of clinicians. Namely, the clinician will open a large number of image files during the process of selecting the one, two or three images he or she wishes to study or compare. This creates a huge amount of network traffic, bearing in mind how large some of the image files may be. With the invention, the clinicians image selection can be done purely on the basis of the thumbnails, which have a very small data size. The only image files that are opened are the image files of the one, two or three images the clinician is actually interested in studying. The reduction in network traffic, and thus strain on the infrastructure, is therefore considerable. The invention should therefore be able to deliver a significant increase in network speed as seen from a user perspective.

Further features of the first aspect of the invention are now described.

The first dimension can conveniently be horizontal so as to provide a column for each date and the second dimension vertical so as to provide a row for each anatomical feature. Alternatively, the opposite arrangement could be used with the rows and columns swapped.

The rows and columns are preferably provided with anatomical feature labels, such as R KNEE, L TIBIA etc, and date labels in an appropriate format.

The graphical user interface provided by the overview screen can be rendered more intuitive in the case that the anatomical features, typically body parts, are sorted according to anatomical position, e.g. from head to foot. Within this schema, a convention of right before left (or the opposite) can be followed.

In a preferred embodiment, the date and anatomical feature for each of the image files is identified by analyzing a header portion of the image file. This solution can be implemented when the image files conform to the DICOM standard. Alternatively, the date and anatomical feature for each of the image files could be identified by analyzing a separate file or database including links to the image files.

Preferably, the display only includes anatomical features for which an image file exists. Clearly there is no merit in displaying a blank row in the display, and it will reduce the screen area that remains for displaying thumbnails of interest.

In a preferred embodiment, the display includes a maximum of one type of view, e.g. projection, for each anatomical feature, any other views of that anatomical feature not being displayed. For example, knee X-rays are almost always taken in pairs, with an anterior-posterior (AP) view and a lateral view. It is preferred in this example that the display only shows thumbnails relating to the AP view, with the lateral views being suppressed. This reduces the number of display rows and therefore allows the remaining rows to be shown with larger thumbnails to aid interpretation. More fundamentally, it reduces the information content of the display, thereby aiding the user interface.

The type of view could be identified by analyzing a header portion of the image file, such as an image file conforming to the DICOM standard. Alternatively, the type of view could be identified by analyzing a separate file or database including links to the image files. An example of this would be an ‘Analyze’-based system.

The overview screen can be used as a gateway to an anatomical feature specific screen. This can be done by user driven selection of a specific one of the anatomical features in the overview which prompts display of an anatomical feature specific screen which displays the medical images specific to the selected anatomical feature as a toolbar adjacent to an image viewing area, wherein the toolbar includes thumbnails of the medical images sorted by date in a further first dimension and projection in a further second dimension, if multiple views exist.

In the anatomical feature specific screen, medical images of projections suppressed from the overview screen will be displayed so that all of the medical images specific to the selected anatomical feature are shown.

It will be understood that the anatomical feature specific screen can also be used independently of the overview screen.

Accordingly a second aspect of the invention provides a method of viewing a plurality of medical images of an individual patient stored as image files on a computer system, comprising: selecting a plurality of image files relating to a specific anatomical feature of the individual patient; and presenting the medical images specific to the selected anatomical feature as a toolbar adjacent to an image viewing area, wherein the toolbar includes thumbnails of the medical images sorted by date in a first dimension and view in a second dimension, if multiple views exist.

The first dimension of the toolbar can be horizontal so as to provide a column for each date and the second dimension vertical so as to provide a row for each view.

A variety of arrangements of the thumbnails within the toolbar is possible. The toolbar can be positioned as a horizontal strip below or above the image viewing area. Alternatively, the toolbar can be split into two horizontal strips with thumbnails for one view (e.g. AP projection) below and thumbnails for another view (e.g. lateral projection) above the image viewing area. Another toolbar arrangement is with the first dimension vertical so as to provide a row for each date and the second dimension horizontal so as to provide a column for each view. In this alignment, the toolbar can be positioned as a vertical strip to the left or right side of the image viewing area. The toolbar could also be positioned as vertical strips with one view to the left side and another view to the right side of the image viewing area.

The date and view for each of the image files can be identified by analyzing a header portion of the image file, for example if the image files conform to the DICOM standard. Alternatively, the date and view for each of the image files can be identified by analyzing a separate file or database including links to the image files.

It has been found useful to highlight the thumbnail of any medical image currently displayed on the image viewing area. This provides an intuitive way to link a currently displayed medical image to the toolbar, thereby allowing the user to appreciate where the currently displayed medical image fits into the overall chronology of medical images taken of that patient's knee or other anatomical feature.

It is often the case the a user will wish to display pairs of medical images, such as AP and lateral views of the same anatomical feature taken at the same time, or today's and the last previous AP projection of an anatomical feature. A useful tool for aiding this selection is provided if the user driven selection is done by positioning an icon and the positioning of the icon in a border region between two thumbnails adjacent in the first or second dimensions allows simultaneous selection of adjacent pairs of thumbnails for display on the image viewing area.

Further aspects of the invention relate to a computer program product for handling a patient record comprising a plurality of medical images stored as image files on a computer system, the computer program product being operable to carry out the method of the first or second aspects of the invention. The computer program product is preferably installable on web browsers to provide PACS viewing software that can be used outside radiology departments or other hospital departments.

Other aspects of the invention relate to a computer system operable to carry out the method of the first or second aspects of the invention.

Still further aspects of the invention relate to a computer network comprising: a file store containing a library of medical image files; and a computer workstation connected to the file store over a network and operable to carry out the method of the first or second aspects of the invention by accessing the file store.

### BRIEF DESCRIPTION OF THE DRAWINGS

For a better understanding of the invention and to show how the same may be carried into effect reference is now made by way of example to the accompanying drawings in which:

FIG. 1 shows an orthopedic surgeon working with conventional X-ray films on a lightboard;

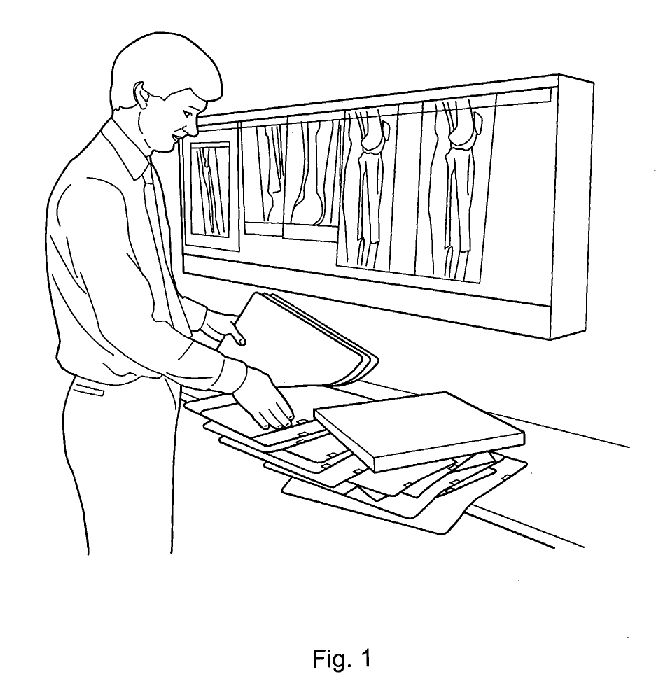

FIG. 2 shows an image selection page of a conventional PACS system;

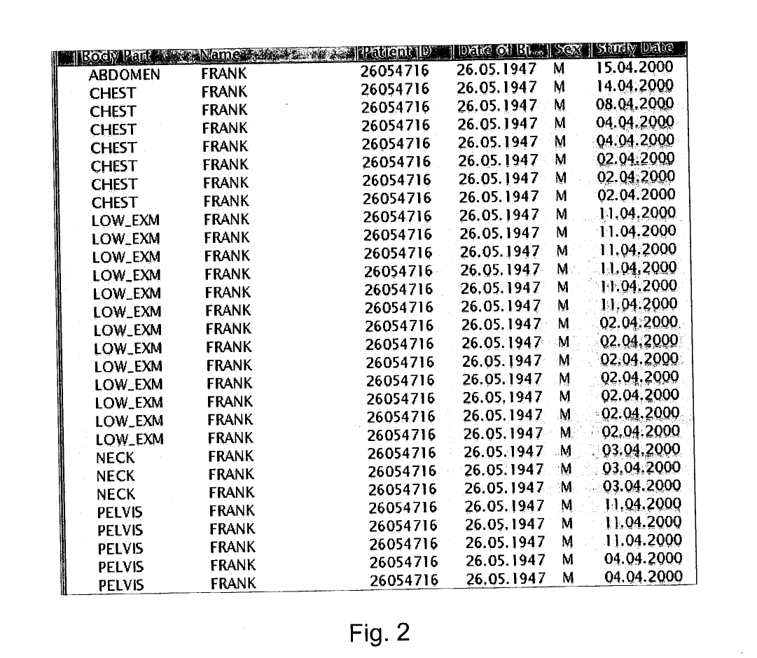

FIG. 3 is a schematic diagram showing an exemplary network of diagnostic devices and associated equipment;

FIG. 4 is a schematic diagram representing the internal structure of a file which conforms to the DICOM standard;

FIG. 5 shows an overview screen of a first patient's medical image file history according to an embodiment of the invention, the first patient having suffered multiple fractures in a road traffic accident;

FIG. 6 shows the overview screen of FIG. 5 after selection of a row relating to image files of the left tibia of the patient;

FIG. 7 shows a body part screen entered through the selection of FIG. 6 in which image files relating to the left tibia are presented in a toolbar adjacent a ‘darkboard’;

FIG. 8 shows the body part specific screen after selection of the most recently taken AP projection of the left tibia;

FIG. 9 shows the body part specific screen after selection of the corresponding lateral image of the left tibia;

FIG. 10 shows the body part specific screen returned to the state of FIG. 7 by re-initialization to remove the images shown in FIG. 9;

FIG. 11 shows the body part specific screen after selection of the earliest lateral image of the left tibia;

FIG. 12 shows the body part specific screen after selection of a later lateral image of the left tibia;

FIG. 13 shows the body part specific screen after selection of the most recent lateral image of the left tibia;

FIG. 14 shows the overview screen of FIG. 5 once more, following return of the user to this level;

FIG. 15 shows an overview screen of a second patient's medical image file history according to an embodiment of the invention, the second patient being a rheumatoid arthritis sufferer;

FIG. 16 shows the overview screen of FIG. 15 after selection of a row relating to image files of the right knee of the patient;

FIG. 17 shows a body part screen entered through the selection of FIG. 16 in which image files relating to the right knee are presented in a toolbar adjacent a ‘darkboard’;

FIG. 18 shows the body part specific screen after selection of a first AP image of the right knee;

FIG. 19 shows the body part specific screen after selection of a second AP image of the right knee taken immediately prior to implant surgery;

FIG. 20 shows the body part specific screen after selection of a third AP image of the right knee taken immediately following the implant surgery;

FIG. 21 shows the overview screen of FIG. 15 once more, following return of the user to this level;

FIG. 22 shows the overview screen of FIG. 21 after selection of a row relating to image files of the pelvis of the patient;

FIG. 23 shows a body part screen entered through the selection of FIG. 22 in which image files relating to the pelvis are presented in a toolbar adjacent a ‘darkboard’; and

FIG. 24 shows the body part specific screen after selection of a pelvic image taken prior to implantation of a hip replacement.

### DETAILED DESCRIPTION

Embodiments of the present invention will be described hereinafter and in the context of a computer-implemented system, method and computer program product. Although some of the present embodiments are described in terms of a computer program product that causes a computer, for example a personal computer or other form of workstation, to provide the functionality required of some embodiments of the invention, it will be appreciated from the following description that this relates to only one example of some embodiments of the present invention. For example, in some embodiments of the invention, a network of computers, rather than a stand-alone computer, may implement the invention. Alternatively, or in addition, at least some of the functionality of the invention may be implemented by means of special purpose hardware, for example in the form of special purpose integrated circuits (e.g., Application Specific Integrated Circuits (ASICs)).

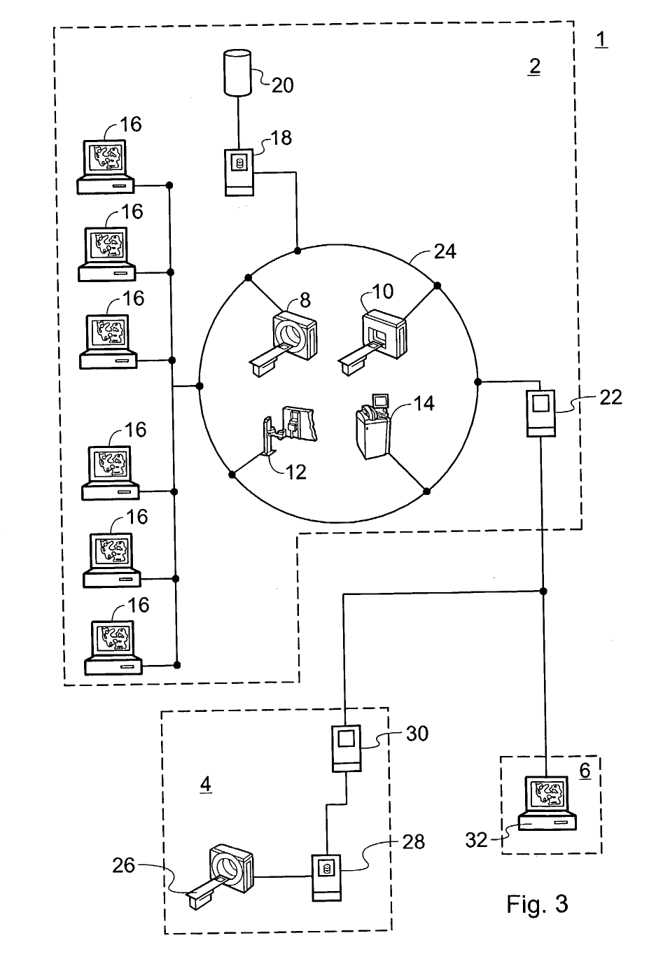

FIG. 3 is a schematic representation of an exemplary network 1 of computer controlled diagnostic devices, stand-alone computer workstations and associated equipment. The network 1 comprises three components. There is a main hospital component 2, a remote diagnostic device component 4 and a remote single user component 6. The main hospital component 2 comprises a plurality of diagnostic devices, in this example, a CT scanner 8, a MR imager 10, a DR device 12 and a CR device 14, a plurality of computer workstations 16, a common format file server 18, a file archive 20 and an internet gateway 22. All of these features are inter-connected by a local area network (LAN) 24.

The remote diagnostic device component 4 comprises a CT scanner 26, a common format file server 28 and an internet gateway 30. The CT scanner 26 and file server 28 are commonly connected to the internet gateway 30, which in turn is connected via the internet to the internet gateway 22 within the main hospital component 2.

The remote single user component 6 comprises a computer workstation 32 with an internal modem (not shown). The computer workstation 32 is also connected via the internet to the internet gateway 22 within the main hospital component 2.

The network 1 is configured to transmit data within a standardized common format. For example, the CT scanner 8 initially generates a source data set, i.e. a 3-D image data set, from which an operator may derive an appropriate 2-D image. The 2-D image is encoded in a standard image data format and transferred over the LAN 24 to the file server 18 for storage on the file archive 20. A user working on one of the computer workstations 16 may subsequently request the image, the file server 18 will retrieve it from the archive 20 and pass it to the user via the LAN 24. Similarly, a user working remotely from the main hospital component 2, either within the remote diagnostic device component 4, or the remote single user component 6, may also access and transmit data stored on the archive 20, or elsewhere on the network 1.

The software operating on or from the computer workstations 16, 32 is configured to conform to the common image data format. The standardization of the image data format ensures that different software applications on the computers 16, 32, the file servers 18, 28 and file archive 20 and the output from the different computer controlled diagnostic devices 8, 10, 12, 14, 26 can share image data.

The preferred image data format currently employed for medical applications is the “Digital Imaging and Communications in Medicine” format, usually referred to as DICOM. The DICOM standard is published by the National Electrical Manufacturers' Association of America.

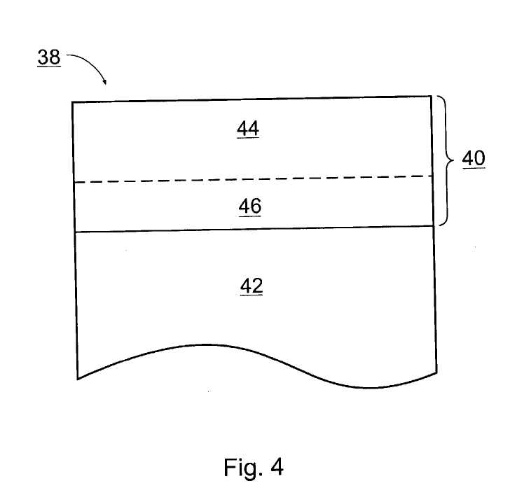

FIG. 4 is a schematic representation of a computer file 38 which is conformant to the DICOM standard. The computer file 38 contains a header portion 40 and an image data portion 42. The header portion 40 is divided into a first header portion 44 and a second header portion 46. The DICOM standard provides the image data portion 42 for storage of the data comprising an image in a standard image data format, and the header portion 40 for storage of ancillary data associated with the image. The first header portion 44 is provided for storage of details which are commonly used and explicitly specified in the DICOM standard. These details are divided into modules such as; patient module, visit module, study module, results module, interpretation module, common composite image module, modality specific module. Within these modules, the inclusion of individual details may be mandatory, conditional or optional. The second header portion 46 is provided for storage of user specific information and comprises what are commonly called private tag information.

These can be any details which a user would like to store with an image, but which are not specifically provided for by the DICOM standard for inclusion in the first header portion 44. A typical maximum size for the header portion 40 is 16 kilobytes.

To implement the embodiment of the invention described in the following the header of each DICOM file will need to include the following labels or tags:

1) the date the image was taken

2) the side (right or left)

3) the anatomical feature or body part (for instance tibia, ankle, knee)

4) the view or projection (AP, lateral and “other”).

“Other” is used as a view label as a catch-all to cope with the occasional oblique and other special view.

The labels will typically be in part in the first header portion 44, in the case of labels that relate to data defined as mandatory (or optional) in the relevant module(s) of the DICOM standard, and in part in the second header portion 46 as private tags in the case of labels that relate to data that are not specifically provided for by the relevant module(s) of the DICOM standard.

In the case that the graphical user interface embodying the invention relies on private tags in the header, it will be important to ensure that the image files are correctly set up before applying the graphical user interface software. This can be ensured by a combination of rigorous practice by the departments that acquire the medical images in combination with later editing when needed to correct errors or omissions made at the time the image files were created.

Although the following description takes the example of DICOM, other formats may be used. For example a format such as “Analyze” which stores the image data in one file (*.img) and the header data in another file (*.hdr) could be used.

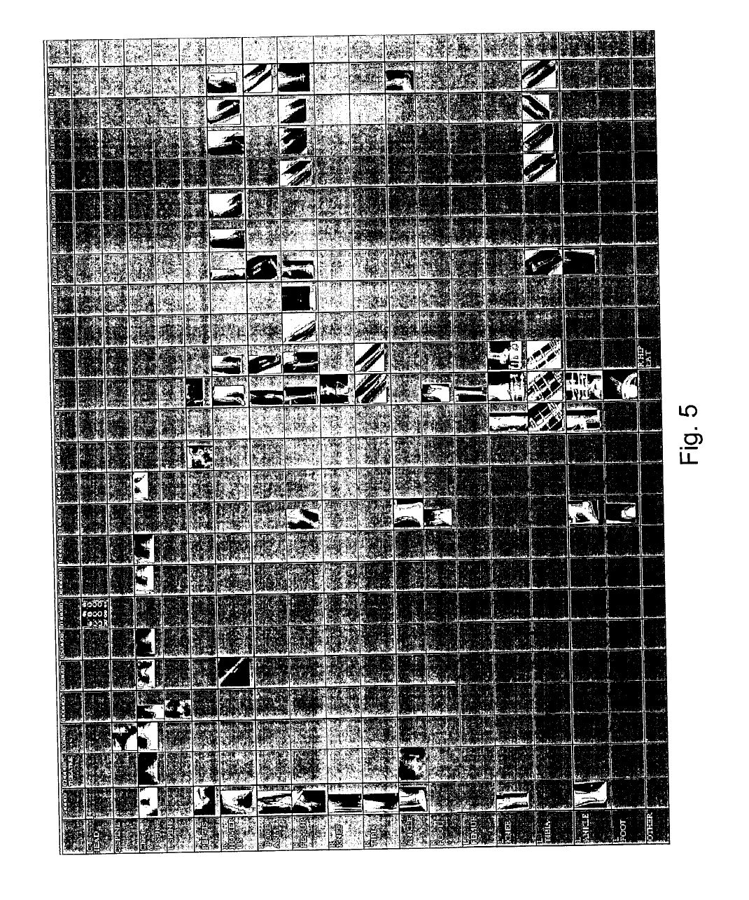

FIG. 5 shows an overview screen of a first patient's medical image file history according to an embodiment of the invention, the first patient having suffered multiple fractures in a road traffic accident. The overview screen shows the whole radiographic history for the patient in question.

The patient overview screen is composed of a two-dimensional grid of thumbnails of the medical images, in which the thumbnails are sorted by date in the horizontal direction and body part in the vertical direction. Time moves from left to right, with the most recent images being positioned rightmost and the earliest images leftmost. Images taken on the same day are all shown in the same column. The images are sorted in the vertical direction in an anatomical fashion, starting with head images at the top and systematically progressing down the body to the feet and toes. The convention of showing right-side images before left-side images is also adopted, so that, for example, the right knee images are shown in a row positioned above the left knee images. The rows and columns are also provided with body part labels, such as R KNEE, L TIBIA etc, and date labels in an appropriate format.

Not all the images are shown in this screen. Only images of one projection of each body part are shown, since this is enough to identify the fact that there are images of that body part in the patient history. For instance, for the knee, images AP views are shown, but not lateral images, even if these exist for the patient. It is not customary always to take lateral views, but an AP view is always taken. Patella skyline views is an example of an “other” projection.

A look up table of the form shown in Table 1 below is used to select which projections are to be shown in, and which are to be suppressed from, the overview screen. In each case, the projections to be shown are highlighted in black. The presence of a question mark indicates that it is optional in the system implementation whether include that projection in the overview screen. For most body parts, only a single projection is used in the overview screen, but for some body parts there are more than one projection selected for display in the overview screen.

TABLE 1

| | |
|---|---|
| HEAD | 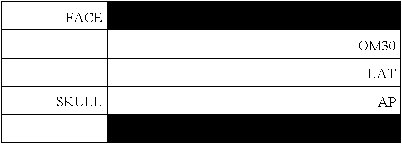 |
| C SPINE | 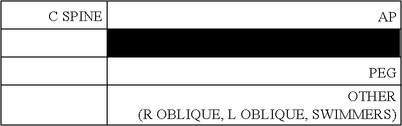 |
| CHEST | 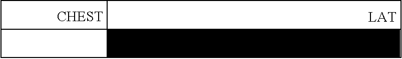 |
| ABD | 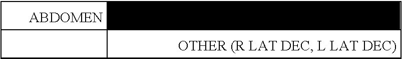 |
| SPINE | 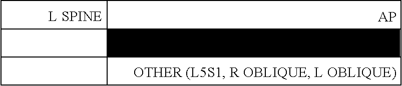 |
| PELVIS | 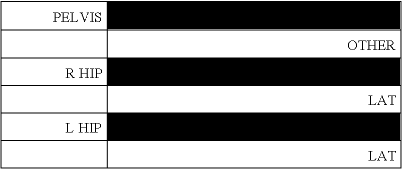 |
| LOWER | 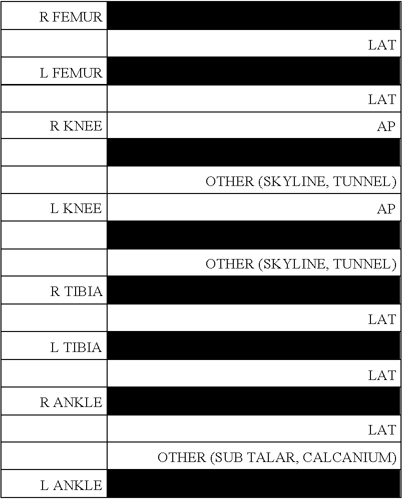 |
| | 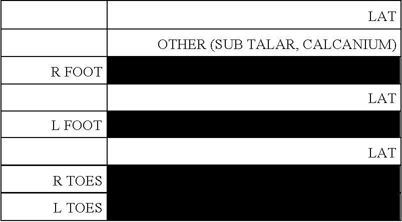 |
| UPPER | 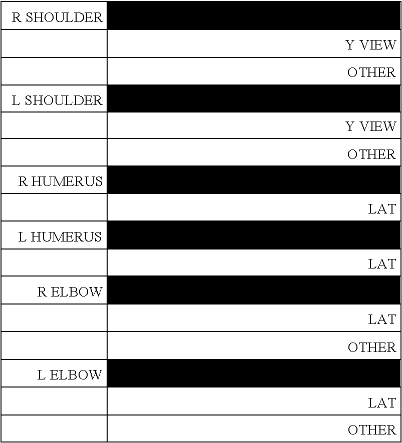 |
| | 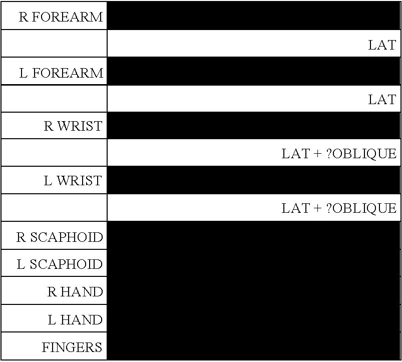 |

The graphic representation of the patient's history in the overview screen gives a vast amount of information, even without any prior knowledge of the patient's history. It is possible at a glance to understand many key aspects of what has happened to this patient. The surgeon can tell that the patient was admitted on 2 Apr. 2000, that he was seriously ill, and that he had numerous body parts X-rayed on admission. It is even possible to see some fractures on the thumbnails despite their small size. Another striking feature is the fact that the patient had chest X-rays taken every day for about 10 days after admission. This is a sure sign that he was in intensive care. It is evident that the patient also had a CT scan of his head during this period so there was obviously some concern about his head, probably because he was being ventilated and so he could not be properly clinically assessed. The fact that there were no other CT scans on his head is also immediately evident from the overview screen, suggesting that the CT scan was normal. It is then possible on around 11 Apr. 2000 and onwards to see many bright bits of metal appearing in the thumbnails, from which it is evident that the orthopedic surgeons got to work and started fixing the broken bones. From the right side of the overview screen, it is evident from simple visual inspection that there are long series of X-rays representing several body parts after surgery (right humerus, right femur, and left tibia) from which it can be deduced that the fractures to these bones were causing prolonged concern. By contrast, other body parts (the right tibia, right foot and left foot) only feature in the early stages, suggesting that there is either no problem with these fractures, or the problems were relatively minor and healed quickly.

It is therefore apparent that a huge amount of relevant clinical information can be deduced from the overview screen without any prior knowledge of the patient's history by the very simple intuitive ordering of thumbnail images of X-rays of selected projections. The intuitive understanding of the patient history comes in part from the layout of the thumbnails which gives the user information on what X-rays were taken when, in part from the fact that the user can see some detail of the image content in the thumbnails notwithstanding their small size, such as major fractures, bone screws, splints and prostheses, and in further part because the user is able to intuitively combine the thumbnail layout and image content information.

A surgeon's task in the fracture clinic may be to identify all the patient's left tibial X-rays first, as that has been an area of concern. This is done by using a user driven icon to click on the left tibia row of the overview screen. A single mouse click highlights that row.

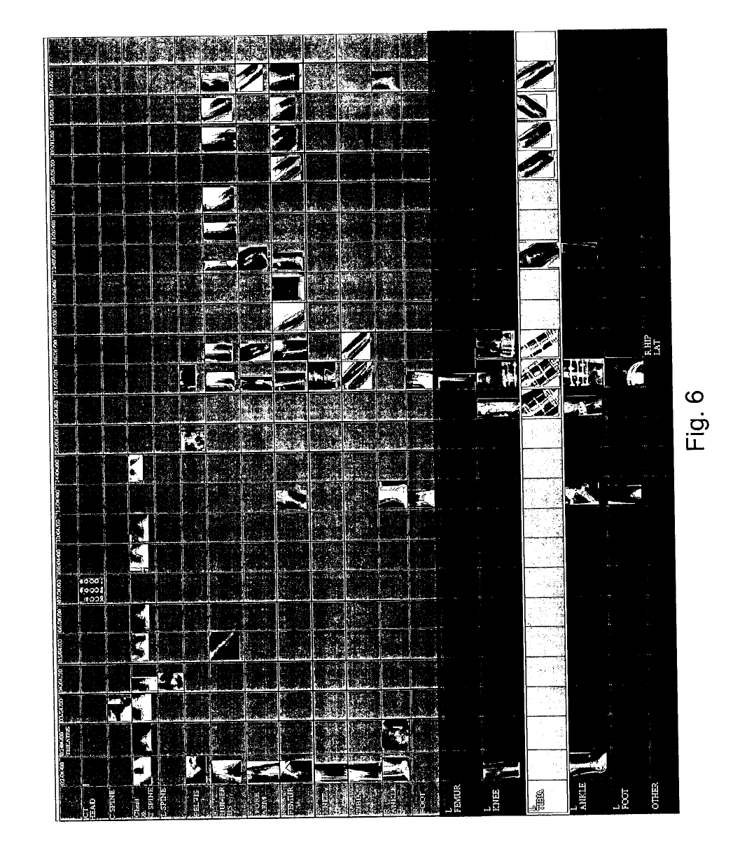

FIG. 6 shows the highlighted left tibia row. Double clicking moves the user through to a new screen, specific to the selected body part, in this case the left tibia.

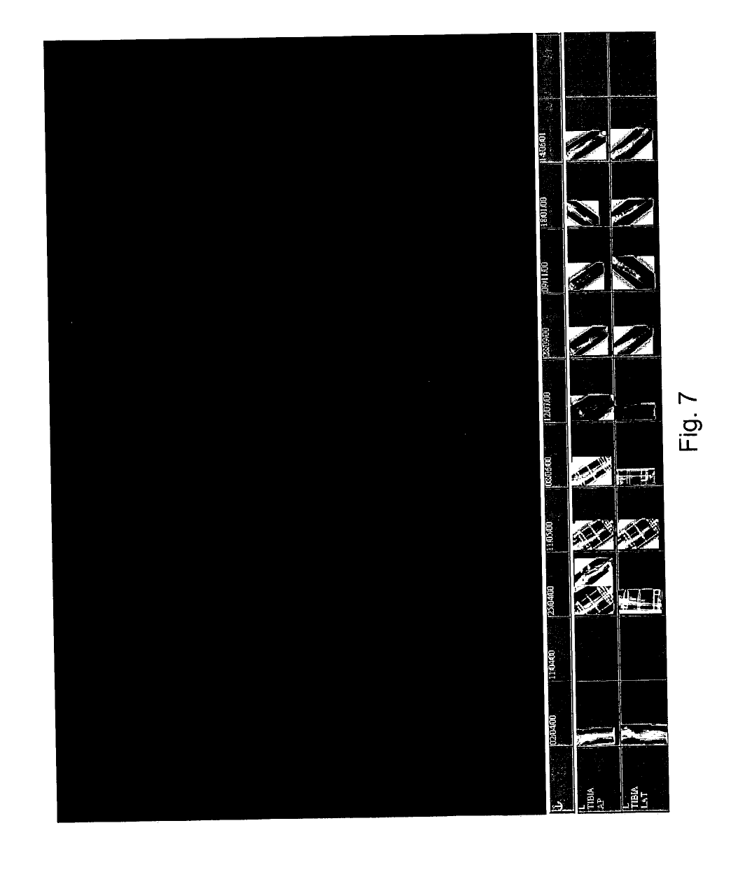

FIG. 7 shows the new screen which is a modified form of a standard PACS viewing screen. As is conventional, a dark image viewing area or ‘darkboard’ is provided, analogous to a conventional lightboard, on which X-ray or other images can be pasted. The viewing screen will also typically contain appropriate toolbars for all the windowing, zoom and tool functions normally provided in a PACS viewing screen. For simplicity of representation, none of these are shown in this or subsequent figures. The conventional PACS viewing screen is supplemented by presenting the medical images specific to the selected body part, left tibia in this case, as a toolbar below the image viewing area. The toolbar shows thumbnails of the medical images sorted by date in the horizontal direction and projection in their vertical direction. (In the case that there is only one projection type for the selected body part, the toolbar would be a simple one dimensional strip sorted in date order.) In the present example, there are two rows of images, the top row showing the tibial AP views, as seen on the overview screen, and the bottom row showing the tibial lateral views taken simultaneously with the AP views. The rows and columns are labeled in a similar fashion to the overview screen. In the PACS viewing screen, the thumbnails can in general be made larger than those in the overview screen because of their lesser number and suppression of dates where no images of that body part exist. Preferably, the user can adjust the dimensions of the toolbar, either interactively on the PACS viewscreen, or via the setting of defaults in a drop down menu option. This allows the user to choose a thumbnail size sufficiently large that the image content can be seen to the desired detail.

Using the thumbnail toolbar, it is then easy to select the most recent images for view. This can be done by moving a user driven icon to the rightmost left tibia AP thumbnail (dated Jun. 14, 2001) and selecting it, e.g. by mouse click or ENTER key of a keyboard.

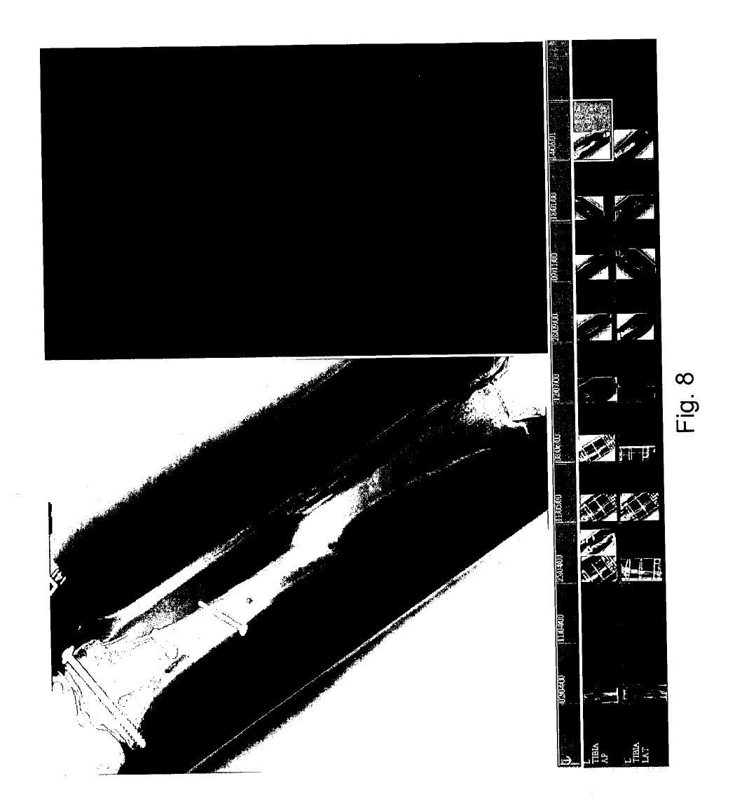

FIG. 8 shows the PACS viewing screen after this selection. The most recent left tibia AP is now pasted onto the image viewing area, and the thumbnail highlighted so that it is evident which image is currently being displayed on the image viewing area.

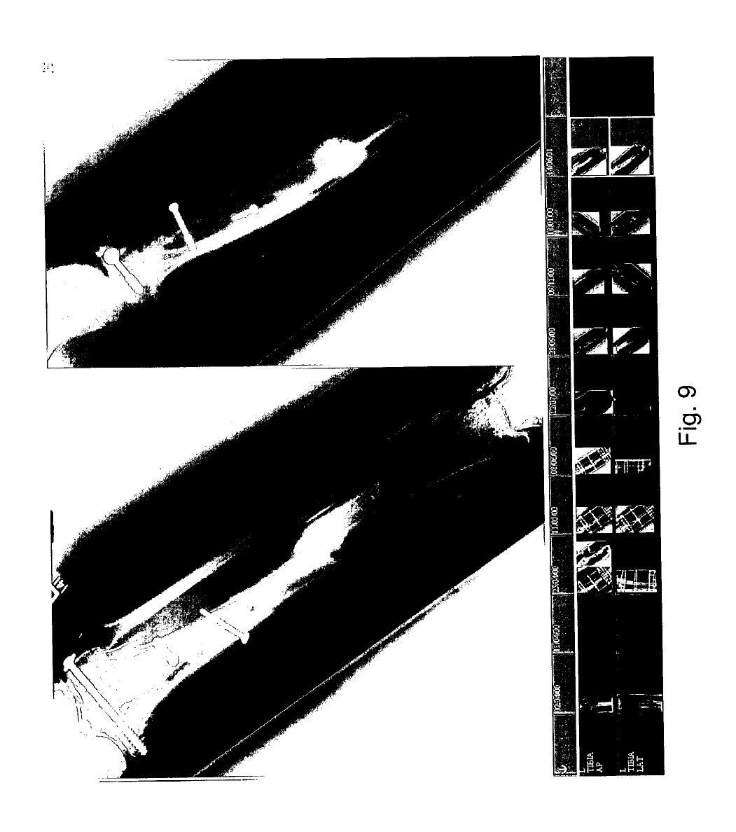

FIG. 9 shows the PACS viewing screen after selection of the corresponding lateral view. It can be seen that both AP and lateral projection thumbnails are now highlighted. A useful enhancement which allows simultaneous selection of an AP/lateral projection pair is provided when positioning the icon in the horizontal border region between the two thumbnails results in simultaneous grabbing of both thumbnails. (The same facility can also be used to provide simultaneous selection of like projections which are adjacent in the date sequence, for example to display the most recent lateral projection with the immediately previous lateral projection. This is done by positioning the icon at the vertical border between two adjacent thumbnails)

To summarize this example so far, the surgeon has been able to select and view the most recent pair of left tibia images in a completely intuitive manner with no difficulty. The surgeon has simply entered the initial patient history overview screen, selected the left tibia row, moved through into the PACS viewing screen and then selected the most recent pair of AP/lateral projections of the left tibia.

After studying the most recent AP/lateral image pair to assess the patient's current condition, the surgeon will quite often then wish to view the progression of, say the lateral view, by comparing the original lateral image taken immediately post trauma, with a key intermediate image which is the last image taken with the external fixator present, and with the most recent lateral image, typically from today.

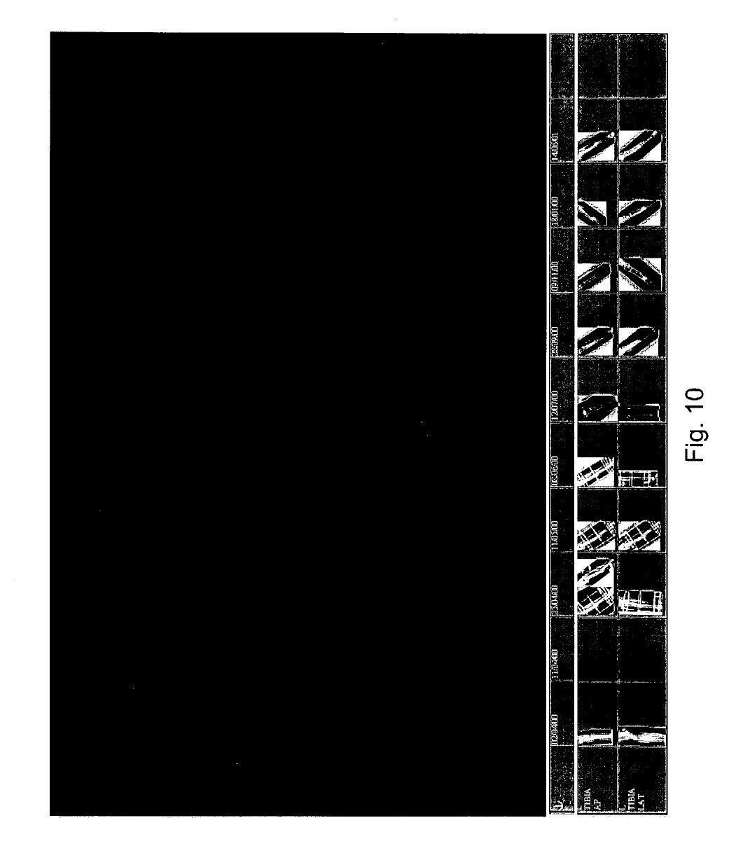

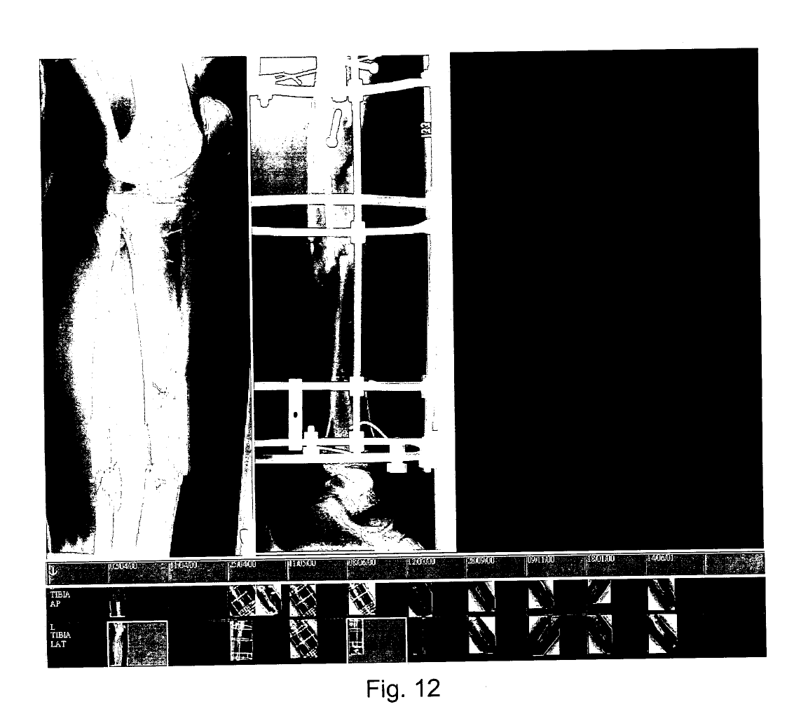

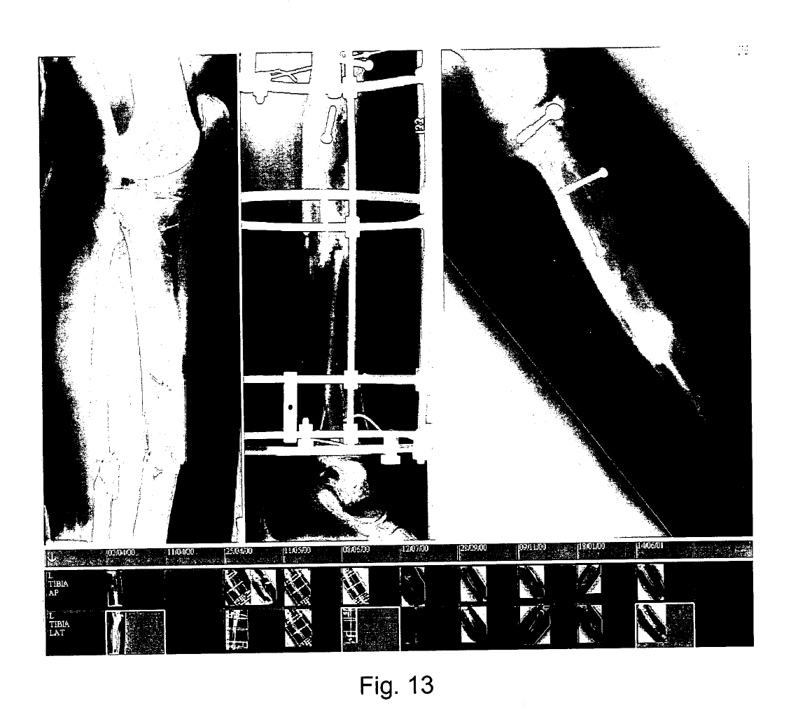

FIGS. 10 to 13 show how the surgeon can progress from the screen state of FIG. 9 to display these images. First, the PACS viewing screen is re-initialized to deselect the images shown in FIG. 9 to arrive at the screen of FIG. 10. Each thumbnail of a displayed image can be highlighted with a different color, with the same color being used to mark the displayed image, e.g. as a colored frame around the border of the image. This links each full displayed image unambiguously to its corresponding thumbnail and hence allows the user to place the displayed image in context in the patient history as will be inferred from the toolbar. It will be appreciated that instead of color differentiation, shading or other distinctive markings could be used.

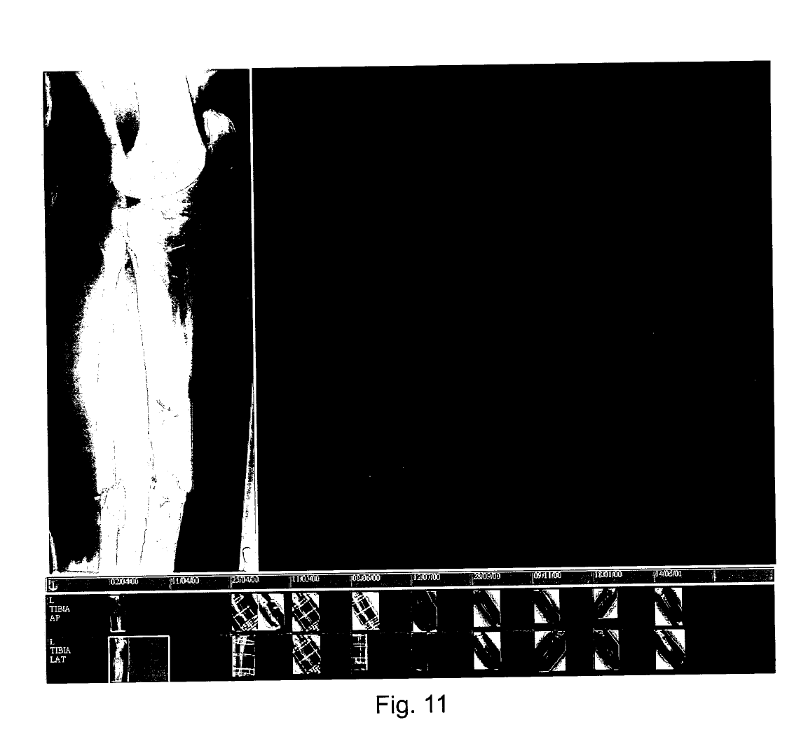

The leftmost left tibia lateral view (2 Apr. 2000) is selected by clicking on the corresponding thumbnail, after which the PACS viewing screen will be as shown in FIG. 10. Then, the last left tibia lateral view showing the external fixator is selected (8 Jun. 2000), after which the PACS viewing screen will be as shown in FIG. 11. This is an example of how the image content of the thumbnails is useful notwithstanding the small size of the thumbnail. It is fully intuitive and trivially easy for the surgeon to select the last image taken with the external fixator present, whereas to make this selection in a pre-PACS world, or with a conventional text-based PACS user interface, the surgeon would either have to look at many images or consult the patient's notes to establish the date on which the external fixator was removed and then look for X-ray image files that predate the fixator removal date by a short while.

Supposing now that the surgeon has viewed the left tibia to his satisfaction, he can then move back to the overview screen.

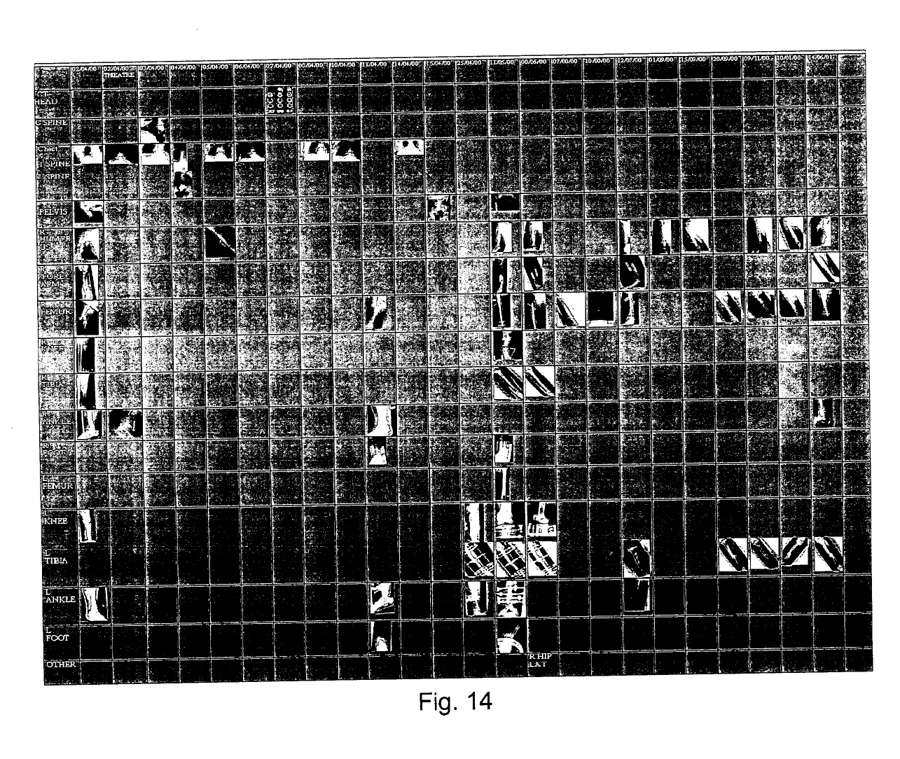

FIG. 14 illustrates this stage. The surgeon is then free to select another body part, for instance the right femur, to see how that has progressed and go through the same types of process as described above for the left tibia. Alternatively, the surgeon can then move to another patient.

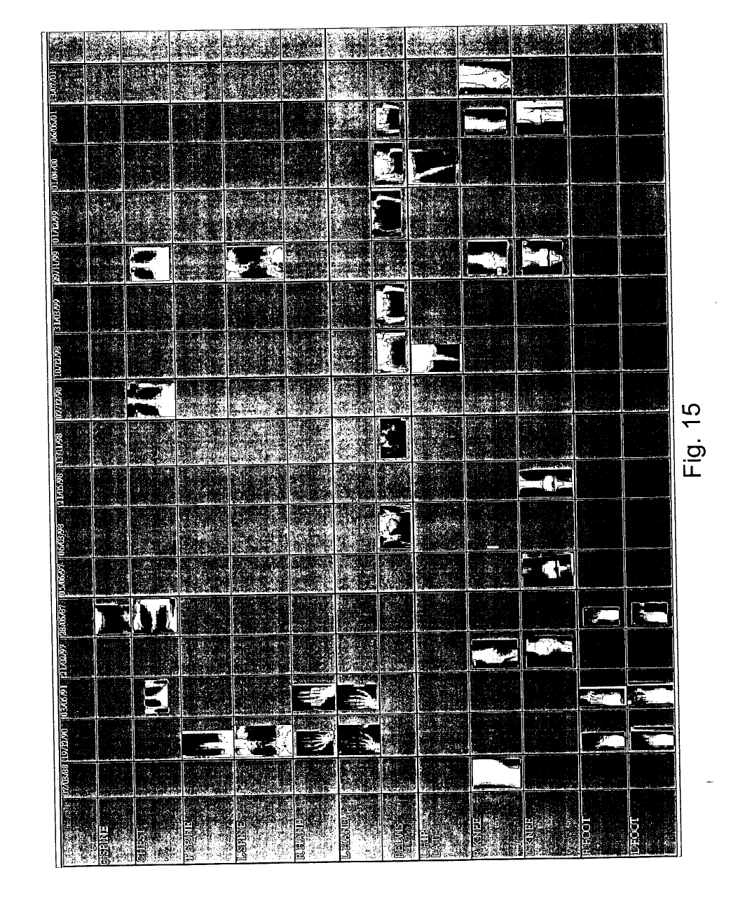

FIG. 15 shows an overview screen of a second patient's medical image file history. The overview screen has the same format as described previously in connection with the trauma patient example. The second patient is a rheumatoid arthritis sufferer. In common with the road accident trauma patient, she has a large dossier of X-ray images tracking the development of her condition. Rheumatoid arthritis is a slowly progressive condition, as can be appreciated from the fact that the timescale goes from 1988 to 2001 in this case.

As with the trauma patient, it is possible to deduce a huge amount of information about the patient history simply from the overview screen. It is possible to see at a glance that this patient presented initially with a right knee problem in 1988, but her wider condition was probably not fully appreciated until 1990 when a series of X-rays were taken on the same day, indicating thoracic spine problems and problems with her hands and feet. She then started to develop large joint problems in 1997 when she presented with right and left knee problems. The left knee progressed rapidly and she had a joint replacement later that year. In 1998 she developed arthritis in her left hip and had a hip replacement. Then at the end in July 2001 she developed right knee problems and had a knee replacement in that side. All this information is deduced in a fully intuitive simple fashion, without having to study any notes. The special arrangement of small area thumbnails thus makes it is possible to glean a huge amount of information about the patient's history. Nothing like this would be possible from a text based image selection system, or a pre-PACS film and lightboard system.

The patient example is now followed through to the PACS viewing screen as in the previous example.

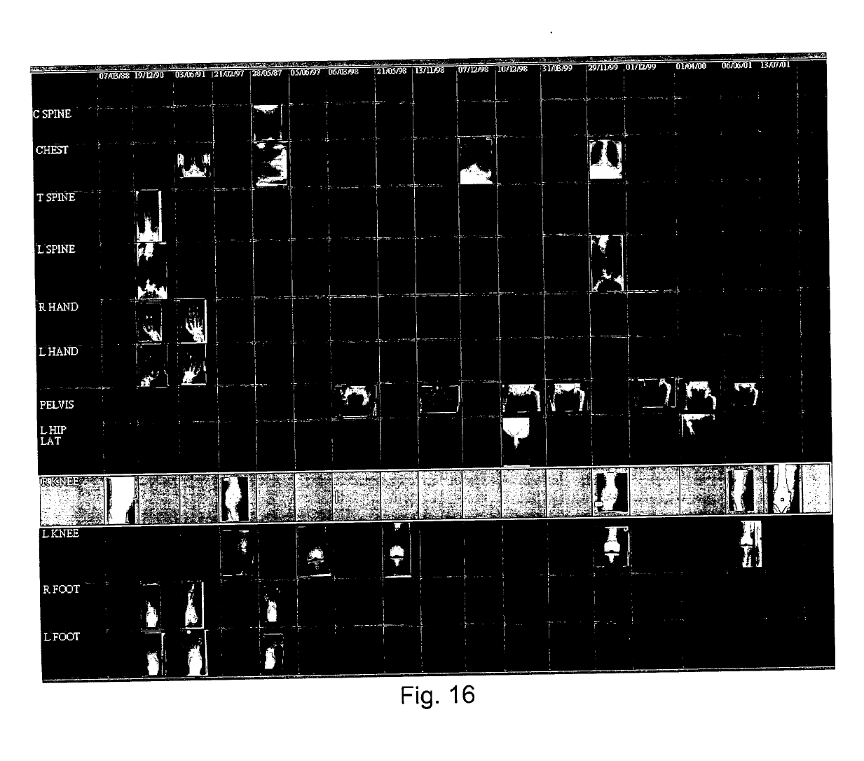

FIG. 16 shows the display state after user selection of the right knee row in the overview screen, with the selected row highlighted. The rows may be cycled through using TAB or UP/DOWN ARROW keys, or selected by a mouse icon.

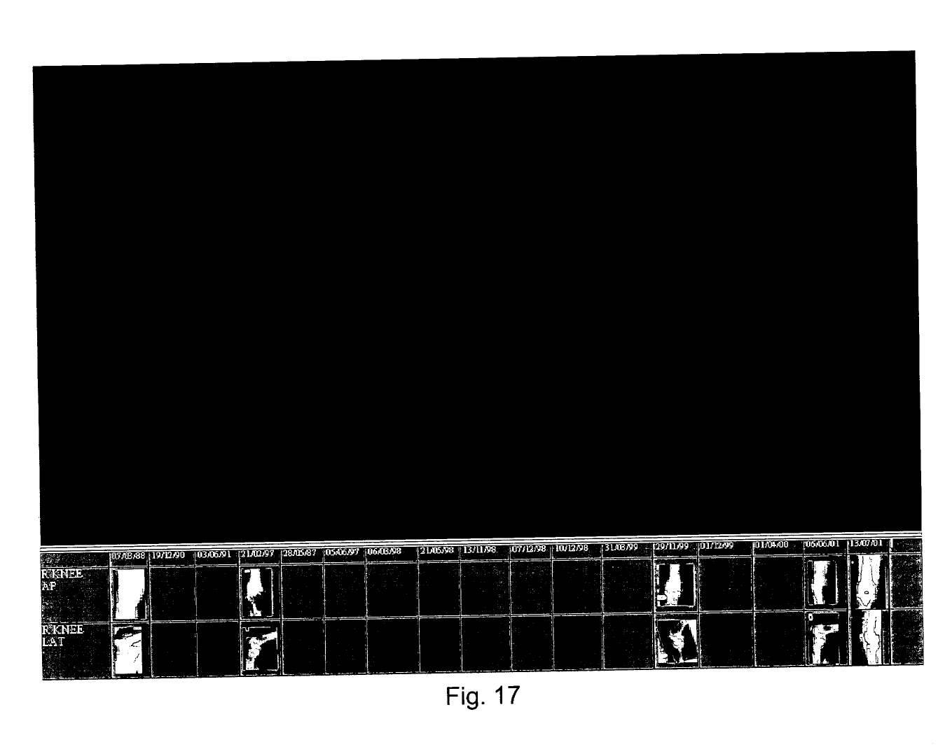

FIG. 17 shows the PACS viewing screen with the right knee toolbar which is arrived at by double mouse clicking the selected row in the overview screen, or pressing the ENTER key, for example. The PACS viewing screen has the thumbnails of the right knee arranged in a two-dimensional array, with AP views along the top and the lateral views, which were suppressed from the overview screen, below. The thumbnails are in date order from left (earliest) to right (most recent). From the thumbnails it can be seen that something started to go wrong on Nov. 29, 1999, so the surgeon may wish to have a look at that in detail. This is done by selecting the AP view for Nov. 29, 1999.

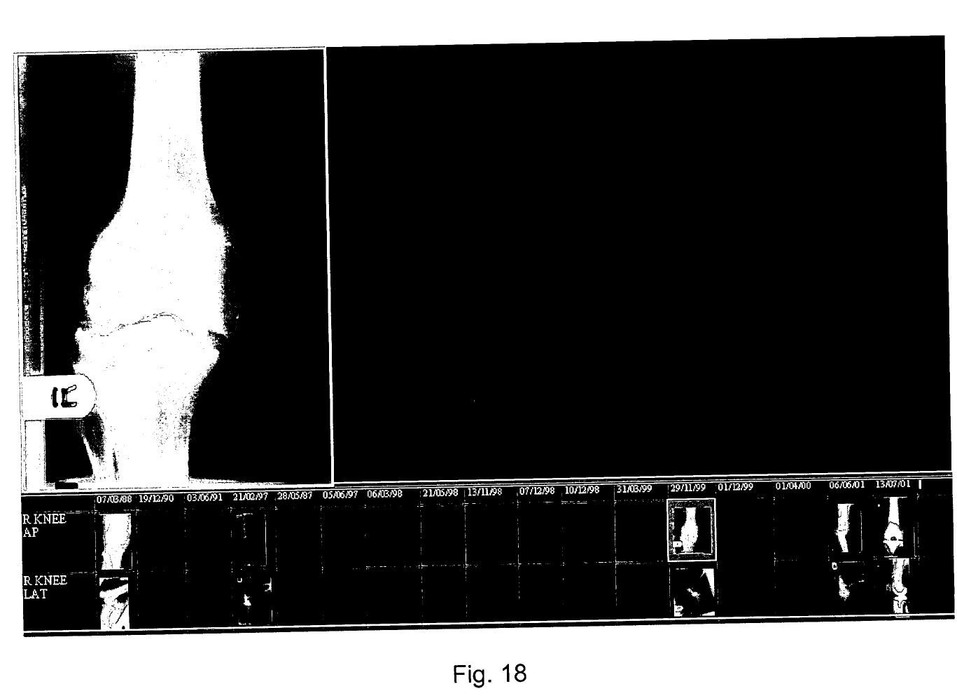

FIG. 18 shows the PACS viewing screen after this selection with the image file being displayed on the image viewing area and the thumbnail highlighted. The progression of the knee condition can be followed by selecting the next AP view from Jun. 2, 2001 and then the most recent AP view from Jul. 13, 2001 in which a knee replacement is evident from the thumbnail.

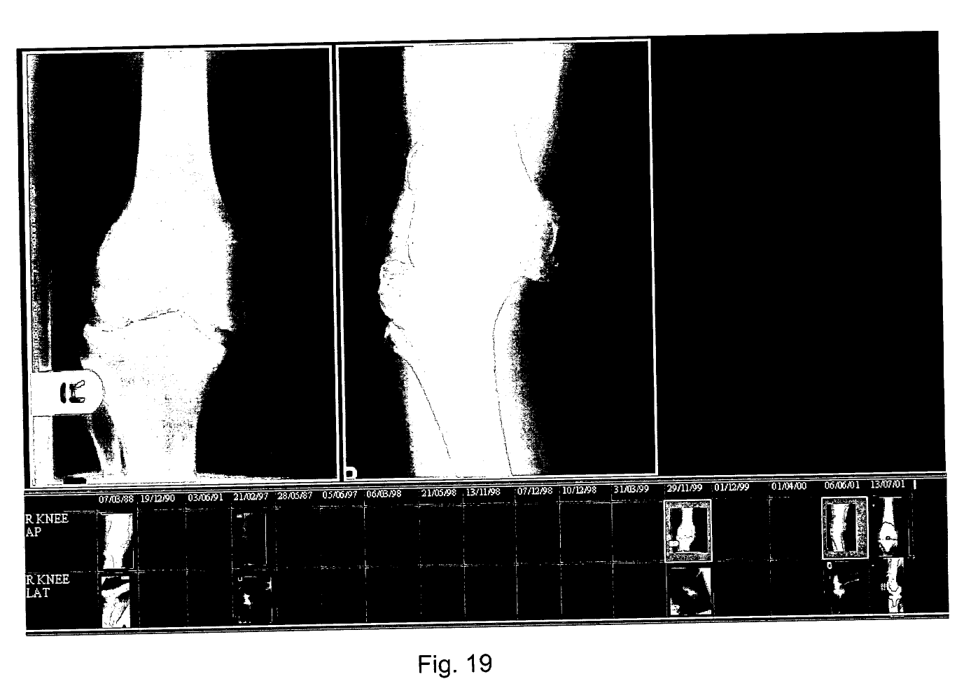

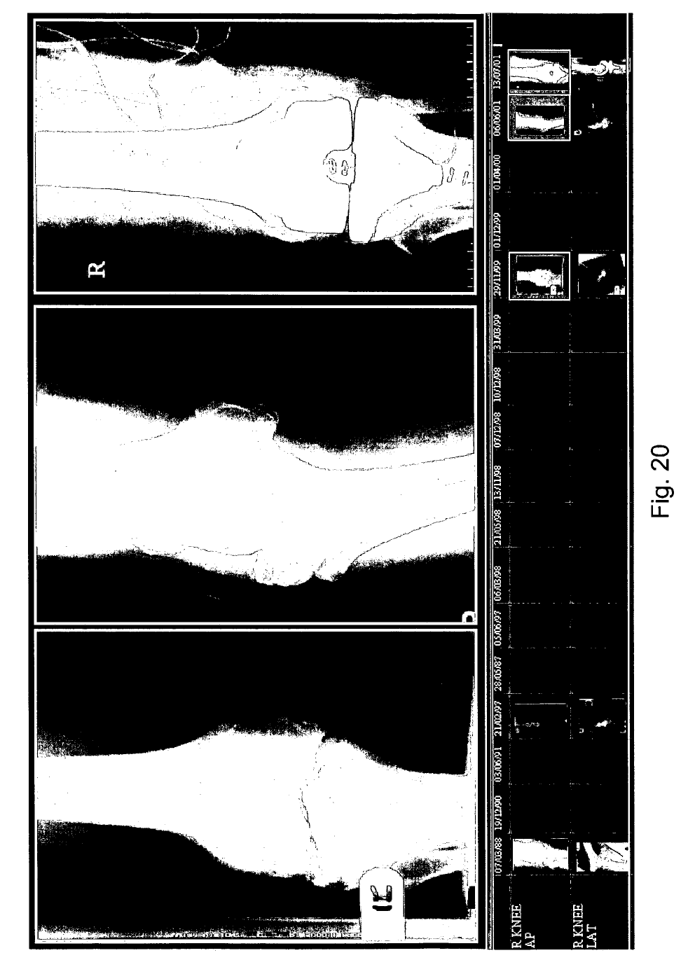

FIGS. 19 and 20 show the PACS viewing screen after each of these two selections. The surgeon has thus been able to accurately select the images that he needs to see to show the progression of the disease in this patient and the resolution by providing a joint replacement. Suppose now that the surgeon has viewed the right knee to his satisfaction, he can then move back to the overview screen.

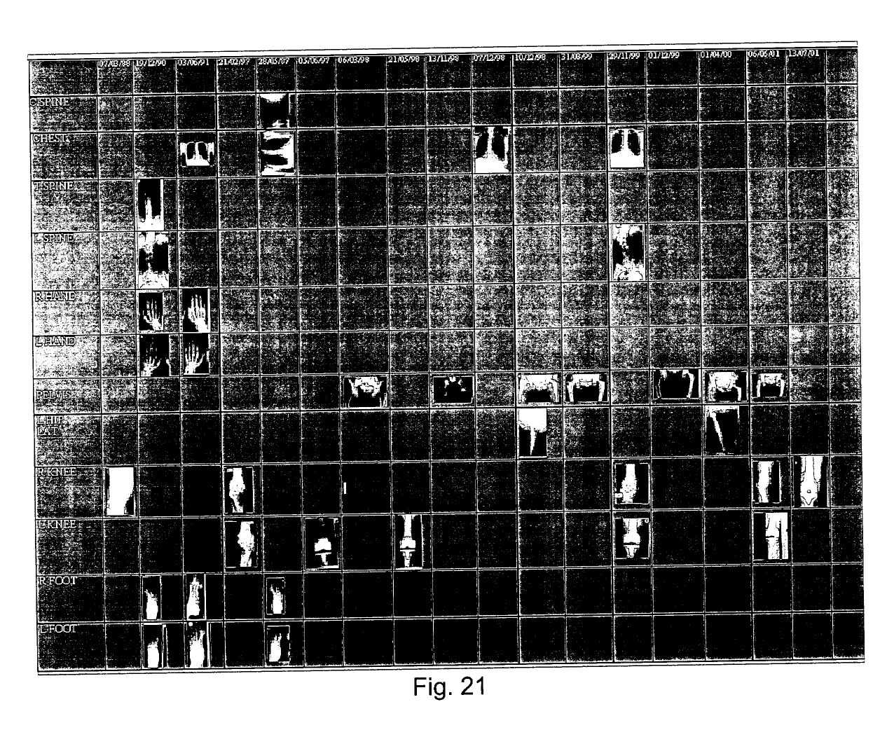

FIG. 21 illustrates this stage. The surgeon is then free to select another body part, for instance the pelvis.

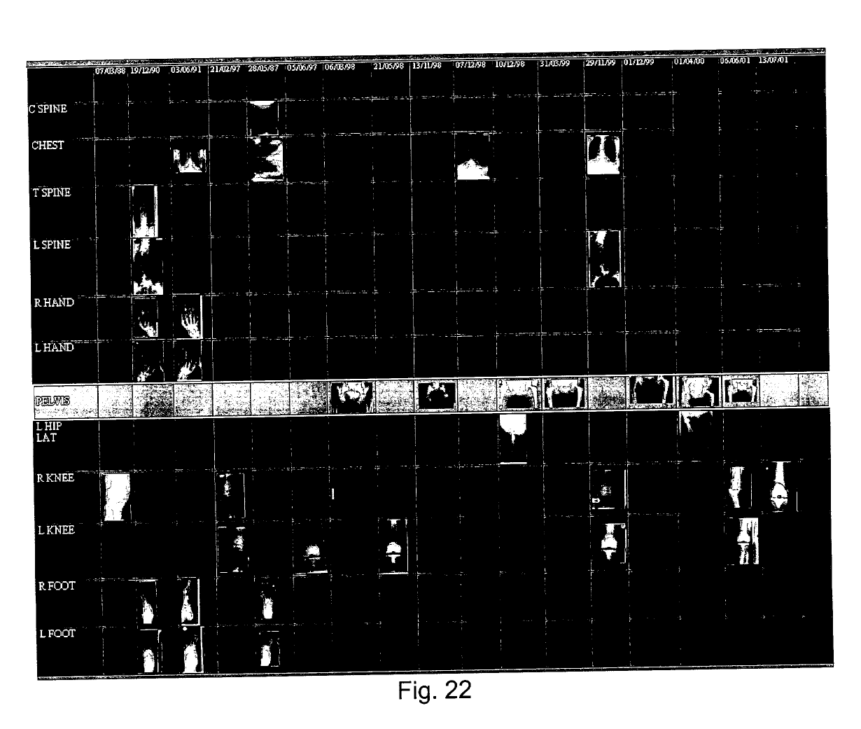

FIG. 22 illustrates the overview screen after user selection of the pelvis row. From here, the user can move to the PACS viewing screen in the manner previously described.

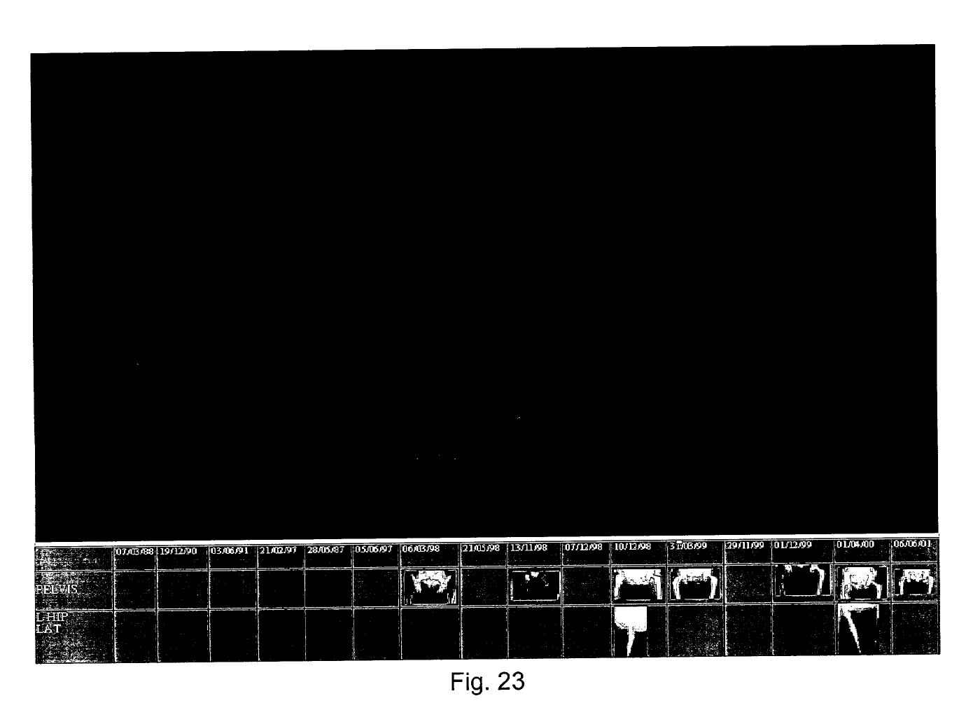

FIG. 23 shows the initial state of the PACS viewing screen after entry through the overview screen. The toolbar shows pelvis (AP view) in the upper row and lateral hip X-rays, when taken, in the lower row. Date sorting from left to right is used as described previously. Suppose the surgeon would like to examine the patient's condition immediately before she had a hip replacement to see what the situation was. It is evident from the thumbnails that the hip replacement first appears in the images on 10 Dec. 1998. The surgeon therefore knows visually from the toolbar that the immediately previous image (13 November 1998) represents the patient's pre-operative condition. The pre-operative pelvic image can therefore be selected without any prior knowledge of the patient's medical history and without having to study the patient's notes.

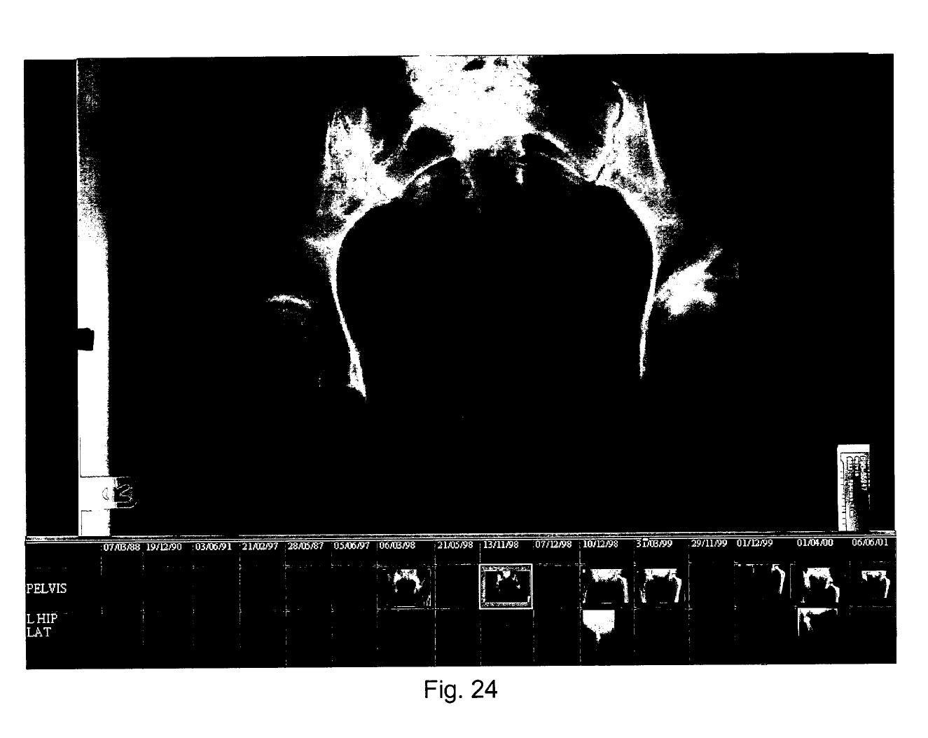

FIG. 24 illustrates the PACS viewing screen after this selection from which the surgeon can study the full pre-operative pelvic image.

Some further design option of the graphical user interface are now discussed.

A standard feature should allow selection of all images taken on the same date (column selection). This could be implemented using a spare mouse button (e.g. right click) for example, or in any number of other ways.

The above examples have only included singe body part (row) selections in the overview screen. An additional feature would be to allow two or more body part (row) selections to be made in the overview screen, so that when the PACS viewing screen is entered the toolbar includes images from more than body part. For example, it can be useful to compare left and right ankle images. In this case the toolbar would typically be four images deep (left ankle AP, left ankle lateral, right ankle AP, right ankle lateral). Another ankle example is when the surgeon wants to view all the images showing one ankle. Normally there would be a small image centred on the ankle and stored in the DICOM file as “R Ankle”. Sometimes the ankle would also be included at the lower end of a long thin tibial image. This would be labelled in the DICOM header as “R Tibia”. So in order to have all the relevant images available for selection in the PACS viewing screen it would sometimes be necessary to make a more complex selection in the overview screen, in this case a combination of ankle and tibia images.

Another option would be to allow user selection of any number of individual thumbnails in the overview screen, with only those being included in the toolbar of the PACS viewing screen. A ‘lasso’ box option could allow any contiguous thumbnail area to be selected for the toolbar. This could be useful for selecting, for example, only post-operative images of a particular body part for inclusion in the toolbar of the PACS viewing screen.

In summary, the invention provides a very easy swift accurate method of choosing images from a PACS system. The overall result will be to provide better care to patients while at the same time using both clinician time and computer infrastructure more efficiently. It is believed that the PACS viewing image selection system described above will massively improve the usability of all PACS systems. The improvements will be especially manifest where large numbers of clinically related image files are taken of different body parts over a sustained period of time. This is common in orthopedic departments, but will also be the situation in other hospital departments, such as rheumatology, maxillo-facial surgery, musculo-skeletal radiology and radiotherapists who will often collect large numbers of MR, CT, bone and CR scans of each patient.

It will be appreciated that while the above examples use anatomical sorting of the thumbnails by body part, other clinically relevant anatomical feature sorting types may be preferable for some kinds of patients.

What is claimed is:

1. A method of representing a patient record comprising a plurality of medical images stored as image files on a computer system, comprising:
selecting a plurality of image files relating to an individual patient;
identifying a date and anatomical feature for each of the image files; and
providing an overview of the medical images of the individual patient on a display as thumbnails sorted by date in a first dimension and anatomical feature in a second dimension.

2. The method of claim 1, wherein the first dimension is horizontal so as to provide a column for each date and the second dimension is vertical so as to provide a row for each anatomical feature.

3. The method of claim 2, wherein the rows and columns are provided with anatomical feature and date labels.

4. The method of claim 1, wherein the anatomical features are sorted in the second dimension according to anatomical position from head to foot.

5. The method of claim 1, wherein the date and anatomical feature for each of the image files is identified by analyzing a header portion of the image file.

6. The method of claim 5, wherein the image files conform to the DICOM standard.

7. The method of claim 1, wherein the date and anatomical feature for each of the image files is identified by analyzing a separate file or database including links to the image files.

8. The method of claim 1, wherein the display only includes anatomical features for which an image file exists.

9. The method of claim 1, wherein the display includes a maximum of one type of view for each anatomical feature, any other views of that anatomical feature not being displayed.

10. The method of claim 9, wherein the type of view is identified by analyzing a header portion of the image file.

11. The method of claim 9, wherein the type of view is identified by analyzing a separate file or database including links to the image files.

12. The method of claim 1, further comprising:
user driven selection of a specific one of the anatomical features in the overview of the medical images of the individual patient; and
presenting the medical images specific to the selected anatomical feature as a toolbar adjacent to an image viewing area, wherein the toolbar includes thumbnails of the medical images sorted by date in a further first dimension and view in a further second dimension, if multiple views exist.

13. The method of claim 12, wherein the further first dimension is horizontal so as to provide a column for each date and the further second dimension is vertical so as to provide a row for each view.

14. The method of claim 12, further comprising:
user driven selection of any of the thumbnails to initiate presentation of the medical image underlying the thumbnail on the image viewing area.

15. The method of claim 12, further comprising highlighting the thumbnail of any medical image currently displayed on the image viewing area.

16. The method of claim 12, wherein the user driven selection is done by positioning an icon, and positioning the icon in a border region between two thumbnails adjacent in the further first or second dimensions allows simultaneous selection of adjacent pairs of thumbnails for display on the image viewing area.

17. A method of viewing a plurality of medical images specific to an individual patient stored as image files on a computer system, comprising:
selecting a plurality of image files relating to a specific anatomical feature of the individual patient; and
presenting the medical images specific to the selected anatomical feature as a toolbar adjacent to an image viewing area, wherein the toolbar includes thumbnails of the medical images sorted by date in a first dimension and view in a second dimension, if multiple views exist.

18. The method of claim 17, wherein the first dimension is horizontal so as to provide a column for each date and the second dimension is vertical so as to provide a row for each view.

19. The method of claim 18, wherein the toolbar is positioned as a horizontal strip below or above the image viewing area.

20. The method of claim 18, wherein the toolbar is positioned as horizontal strips with one view below and another view above the image viewing area.

21. The method of claim 17, wherein the first dimension is vertical so as to provide a row for each date and the second dimension is horizontal so as to provide a column for each view.

22. The method of claim 21, wherein the toolbar is positioned as a vertical strip to the left or right side of the image viewing area.

23. The method of claim 21, wherein the toolbar is positioned as vertical strips with one view to the left side and another view to the right side of the image viewing area.

24. The method of claim 17, wherein the date and view for each of the image files is identified by analyzing a header portion of the image file.

25. The method of claim 24, wherein the image files conform to the DICOM standard.

26. The method of claim 17, wherein the date and view for each of the image files is identified by analyzing a separate file or database including links to the image files.

27. The method of claim 17, further comprising highlighting the thumbnail of any medical image currently displayed on the image viewing area.

28. The method of claim 17, wherein the user driven selection is done by positioning an icon, and positioning the icon in a border region between two thumbnails adjacent in the first or second dimensions allows simultaneous selection of adjacent pairs of thumbnails for display on the image viewing area.

29. A computer program product for handling a patient record comprising a plurality of medical images stored as image files on a computer system, the computer program product being operable to:
select a plurality of image files relating to an individual patient from an image file database;
identify a date and anatomical feature for each of the image files; and
provide an overview of the medical images of the individual patient on a display as thumbnails sorted by date in a first dimension and anatomical feature in a second dimension.

30. The product of claim 29, wherein the first dimension is horizontal so as to provide a column for each date and the second dimension is vertical so as to provide a row for each anatomical feature.

31. The product of claim 30, wherein the rows and columns are provided with anatomical feature and date labels.

32. The product of claim 29, wherein the anatomical features are sorted in the second dimension according to anatomical position from head to foot.

33. The product of claim 29, wherein the date and anatomical feature for each of the image files is identified by analyzing a header portion of the image file.

34. The product of claim 33, wherein the image files conform to the DICOM standard.

35. The product of claim 29, wherein the date and anatomical feature for each of the image files is identified by analyzing a separate file or database including links to the image files.

36. A computer system operable: to select a plurality of medical image files relating to an individual patient from a library of medical image files; to identify a date and anatomical feature for each of the selected medical image files; and to provide an overview of the medical image files of the individual patient on a display as thumbnails sorted by date in a first dimension and anatomical feature in a second dimension.

37. The computer system of claim 36, wherein the first dimension is horizontal so as to provide a column for each date and the second dimension is vertical so as to provide a row for each anatomical feature.

38. The computer system of claim 37, wherein the rows and columns are provided with anatomical feature and date labels.

39. The computer system of claim 36, wherein the anatomical features are sorted in the second dimension according to anatomical position from head to foot.

40. The computer system of claim 36, wherein the date and anatomical feature for each of the image files is identified by analyzing a header portion of the image file.

41. The computer system of claim 40, wherein the image files conform to the DICOM standard.

42. The computer system of claim 36, wherein the date and anatomical feature for each of the image files is identified by analyzing a separate file or database including links to the image files.

43. A computer network comprising:
a file store containing a library of medical image files; and
a computer workstation connected to the file store over a network and operable to select the medical image files that relate to an individual patient from the library, to identify a date and anatomical feature for each of the selected medical image files, and to provide an overview of the medical image files of the individual patient on a display as thumbnails sorted by date in a first dimension and anatomical feature in a second dimension.

44. A computer program product for viewing a plurality of medical images specific to an individual patient stored as image files on a computer system, the computer program product being operable to:
select a plurality of image files relating to a specific anatomical feature of the individual patient; and
present the medical images specific to the selected anatomical feature as a toolbar adjacent to an image viewing area, wherein the toolbar includes thumbnails of the medical images sorted by date in a first dimension and view in a second dimension, if multiple views exist.

45. The product of claim 44, wherein the first dimension is horizontal so as to provide a column for each date and the second dimension is vertical so as to provide a row for each view.

46. The product of claim 44, wherein the first dimension is vertical so as to provide a row for each date and the second dimension is horizontal so as to provide a column for each view.

47. The product of claim 44, wherein the date and view for each of the image files is identified by analyzing a header portion of the image file.

48. The product of claim 47, wherein the image files conform to the DICOM standard.

49. The product of claim 44, wherein the date and view for each of the image files is identified by analyzing a separate file or database including links to the image files.

50. The product of claim 44, wherein the user driven selection is done by positioning an icon, and positioning the icon in a border region between two thumbnails adjacent in the first or second dimensions allows simultaneous selection of adjacent pairs of thumbnails for display on the image viewing area.

51. A computer system for viewing a plurality of medical images specific to an individual patient stored as image files on a computer system, the computer system being operable: to select a plurality of image files relating to a specific anatomical feature of the individual patient; and to present the medical images specific to the selected anatomical feature as a toolbar adjacent to an image viewing area, wherein the toolbar includes thumbnails of the medical images sorted by date in a first dimension and view in a second dimension, if multiple views exist.

52. A computer network comprising:
a file store containing a library of image files storing medical images; and
a computer workstation connected to the file store over a network and operable: to select a subset of the image files relating to a specific anatomical feature of an individual patient; and to present the medical images specific to the selected anatomical feature as a toolbar adjacent to an image viewing area, wherein the toolbar includes thumbnails of the medical images sorted by date in a first dimension and view in a second dimension, if multiple views exist.
